(19) United States
(12) Patent Application Publication
(10) Pub. No.: US 2003/0156497 A1
(43) Pub. Date: Aug. 21, 2003

(54) World timepieces comprising different hour hands

(75) Inventor: Jairo Peynado, Barrnquilla (CO)

Correspondence Address: Jairo Peynado, Cra. 51 79-105 Apto. 401, Barranquilla, CO

(73) Assignee: America America Ltda, Barranquilla (CO)

(21) Appl. No.: 10/078,580

(22) Filed: Feb. 20, 2002

(51) Int. Cl. G04B 19/22

(52) U.S. Cl. 368/21

(57) ABSTRACT

A world timepiece comprising, a Transport Mean (30), which transports a plural number of Pointer Guides (31). Each Pointer Guide (31) are different among each other and each one points to a different time. Additionally, a plural number of Accompany Guides (32), where each one accompanies a city name. The Accompany Guide, that accompanies a chosen city name, is identical to one of the Pointer Guides; this one points to the chosen city time. Also, a plural number of Modifiable-Accompany Guides (35a, 35b, 35c) wherein each one accompanies a city name; each Modifiable-Accompany Guide is equipped to change its appearance, thus, the world timepiece is adjusted to Daylight Saving Time and to Standard Time periods.

This Utility Patent Application is based on the Copyright Number TUX 610 996, Jul. 26, 1993, of the US Copyright Office. This Copyright corresponding to the titled work: The World Time Card. It belongs to America America Ltda. The copyright date is the present Patent Filing Date.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable

### BACKGROUND OF THE INVENTION

1. Field of the Invention

The present invention relates to the shape of the world timepieces with hands, and more specifically to those which have several hour hands in only one dial or time display.

2. The Prior Art

In many airports, hotels, television news etc. is displayed a plural number of conventional clocks of 12 hours dial and hands. Each clock shows the time of a city, whose name appears at the bottom of the corresponding clock. The set of the above described clocks constitutes at present the most common manner to show world time because the world timepieces with hour hands, invented up to this date, are not used, due their deficiencies.

In the Prior Art there are a lot of world clocks which only have one dial and multiple hour hands or equivalent symbols. These hour hands point to different times. In some of these world timepieces the hour hands are different amount each other, as in my world timepieces.

My world timepieces are different because they have a reproduction of each hour hand, which accompanies a city name. These Accompany Hour Hands make the function of a guide as explained further on.

An Accompany Hour Hand or simply an Accompany Guide, which accompanies a city name, was found in only one world timepiece, in the titled work Dial-O-Map. In the Dial-O-Map world timepiece a number appears at the top of a zone map and other identical one at the bottom. Any of these numbers also makes the function of a guide. Due to its structure this is the unique relevant world timepiece in the Prior Art.

The Dial-O-Map has been available to public information, because it is a published work. The Copyright-1955 belongs to the company Cardy Lundmark Co., of Chicago, USA.

The world timepieces with hour hands, including Dial-O-Map world timepiece, present, in general, the following disadvantages:

A) They can not be adjusted to the changes of time applied in many countries; meaning that they inform the wrong time during the 7 months of the period denominated Daylight Saving Time.

B) The geographical names do not have an alphabetical order, fact that makes it difficult to find a desired name. The person who is not well familiarized with world geography has more difficulty.

C) In some of the world timepieces it is necessary to read the instructions to understand them, fact does not allow their use in public areas.

### BRIEF SUMMARY OF THE INVENTION

Accordingly several objects and advantages of my invention are:

A) To provide world timepieces with hour hands, which correctly inform the world time in Standard Time and in Daylight Saving Time.

B) To provide world timepieces with hour hands, which do not need instructions to understand them.

C) To provide world timepieces with hour hands, which are accepted and used

D) To provide world timepieces with hour hands, which present the geographical names in alphabetical order.

E) To provide world timepieces with hour hands, which attract attention for their colors.

F) To provide world timepieces with hour hands, which are economic.

G) To provide world timepieces with hour hands, in small dimensions, used to inform world time to a particular person.

H) To provide world timepieces with hour hands, in large dimensions, used to inform the world time to many people in public areas.

I) To provide world timepieces with hour hands, specifically to be used as an integral part of a telephone directory, useful to the internationalization of communications and trades.

### BRIEF DESCRIPTION OF THE DRAWINGS

FIG. 1 is a frontal view of a Number Guide.

FIG. 2 is a frontal view of my basic world timepiece.

FIG. 3 shows the manner of how the world timepiece of FIG. 2 is adjusted to the time changes, applied in different countries.

FIG. 4 is a frontal view of the world timepiece of FIG. 2, which has been altered due to the use of a conveyor.

FIG. 5 is a frontal view of a world timepiece made in cardboard.

FIG. 6 is an exploded view of a telephone directory world timepiece.

FIG. 7 presents a non-pointed symbol, which induces to read the time.

### DETAILED DESCRIPTION OF THE INVENTION

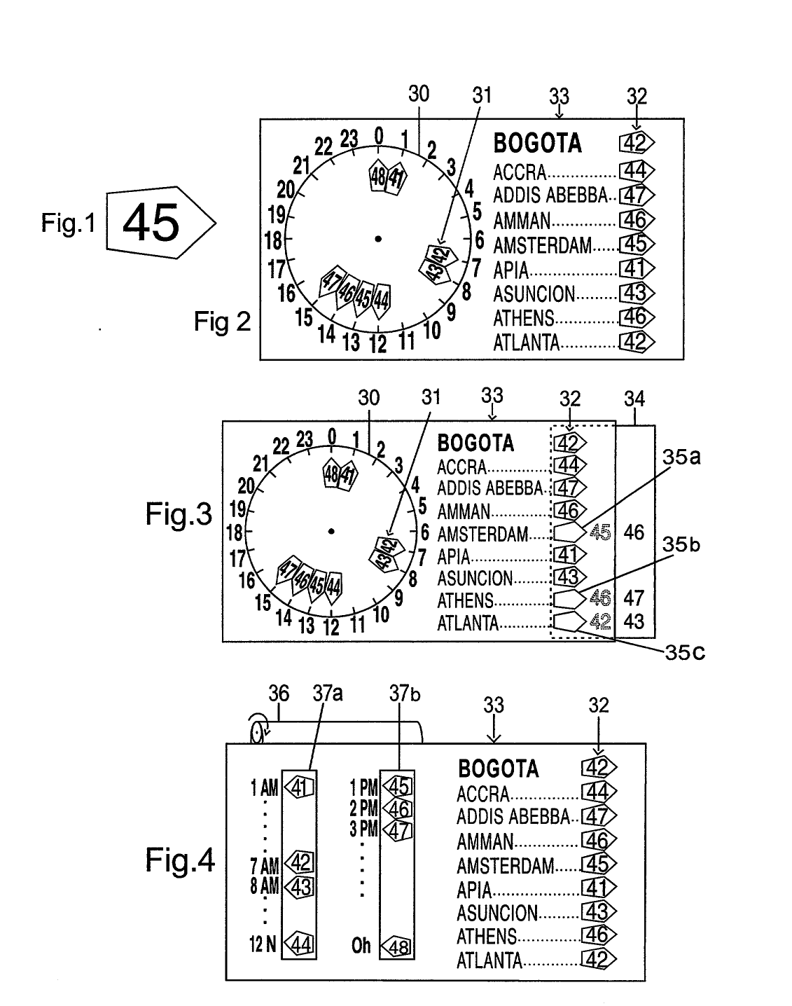

FIG. 1 is a frontal and amplified view of a Number Guide, which has the shape of a spearhead. The Number Guides are essential in my world timepieces. The number serves to identify a guide, serves to differentiate or associate it with other guides; a Number Guide serves to accompany the name of a city, denominated Accompany Guide. It also serves to indicate the time, denominated Pointer Guide.

To elaborate my world timepieces I followed a logical procedure in order that my world timepieces would be organized and likewise have a scientific basis. I took into account that the surface of the earth was theoretically divided into 24 time zones. The time of each zone was fixed in regards to 12:00 hours Greenwich Meridian. The time of a city is in reality the time of the zone in which the city is located; in other words, it is the city zone time. I took two determinations which shall be explained further on.

FIG. 2 shows my basic world timepiece, which uses Pointer Guides and Accompany Guides. It also uses a disc, which rotates with the accuracy of a clock system. To determine the shape of this world timepiece I previously elaborated the Table 1. I took the names of 9 cities, which appear in Column C3. I classified the time of these cities in ascendant order, as it appears in Column C2.

My first determination was to point to each city time or city zone time by a different Pointer Guide, as it appears in Column 1. I numbered each Pointer Guide with an ascendant number. I began with # 41. Accordingly, to indicate 1:00 hour I assigned to the Pointer Guide #41. To indicate 7:00 hour I assigned Pointer Guide # 42. To indicate to 8:00 hour I assigned Pointer Guide # 43, thus I continued numbering the other Pointer Guides.

My second determination was to accompany each city name with an Accompany Guide which I drew in column C4. An Accompany Guide is identical to one of the Pointer Guides; this one appears pointing to the time of the zone in which the city is located. Accordingly, Apia is located in 1:00 hour zone. The 1:00 hour zone is indicated by Pointer Guide # 41, for this reason I accompanied the name of Apia with an Accompany Guide #41. Atlanta is located in 7:00 hour zone. The 7:00 hour zone is indicated by Pointer Guide # 42, for this reason I accompanied the name of Atlanta with an Accompany Guide # 42 and thus successively.

Amman and Athens are city names accompanied with an identical Accompany Guide # 45, meaning that they are located in the same time zone.

Once I concluded Table 1, I began with the elaboration of the world timepiece of FIG. 2. I used a disk 30, in which I drew several Pointer Guides 31 identical to the Pointer Guides that appear in Column C1 and pointing to the same hours. Additionally, the names of the cities that appear in Column C3 I wrote them down in alphabetical order, except the city name in which the clock is installed, name that appear on the top of the list. Further on, I drew next to each city name its corresponding Accompany Guide 32 assigned for the Standard Time, which I took from Column C4.

According to the world timepiece of FIG. 2, when any person wishes to know a city time, for example Amsterdam's time, the # 45 Guide that accompanies Amsterdam's name will attract the attention. It is logical that the person thinks about the meaning. The answer will be known upon observing that in the dial there is another identical guide, with the # 45, pointing to 13:00 hours. The fact to associate the two identical guides will induce the person to think that the time thus pointed to is the time of Amsterdam: 13:00 hours.

In accordance with the above procedure, which is easily followed without explanation, a person can read: the 8:00 hours in Asuncion, the 14:00 hours in Amman etc.

FIG. 3 is a frontal view of the world timepiece of FIG. 2, wherein the Accompany Guides which accompany the names of Amsterdam 35a, Athens 35b and Atlanta 35c appear without number. In those cities it is agreed to advance the clocks one-hour during the Daylight Saving Time period. After this period the clocks are again modified, subtracting the one-hour which had been advanced, thus adjusting them for Standard Time period.

The Accompany Guides that go with the mentioned cities must be equipped to adapt them to the time changes. I denominated this kind of Accompany Guide I denominated as Modifiable-Accompany Guides 35a, 35b, 35c. Modifiable, meaning that the number can be changed for another one as the Modifiable-Accompany Guide changes its appearance.

The Modifiable-Accompany Guide can be achieved, for example, in the following manner: The forepart 33 is a transparent and fixed sheet. The forepart 33 is painted with nontransparent colors, except the Modifiable-Accompany Guides 35a, 35b, 35c which remain transparent. Behind the forepart 33 there is a sliding sheet 34, in which several painted numbers appear. Two of those numbers can be displays, one by one, in each Modifiable-Accompany Guide. This fact occurs when sliding sheet 34 is displaced. Sliding sheet 34 is manually activated but could be automatically operated.

In theory, in Standard Time, a Modifiable-Accompany Guide, that accompanies the chosen city name, is identical to the one of the Pointer Guide; this one points to the chosen city time. In Daylight Saving Time, the Modifiable-Accompany Guide number must be modified in order to be identical to the Pointer Guide number which Points to the following ascending time in the dial.

The theoretical explanation described above is clearly seen in the practical example presented in the world timepiece in this FIG. 3.

Initially we can imagine the world timepiece displaying Standard Time. For this period, the sliding sheet 34 is displaced until the numbers 45, 46 and 42 become visible in the guides of these three cities, thus #45 in the Amsterdam's guide, #46 in the Athens' guide and #42 in the Atlanta's guide. Any person will read: the 13:00 hours in Amsterdam; the 14:00 hours in Athens and the 7:00 hours in Atlanta.

When Daylight Saving Time period is applied, it is necessary to displace sliding sheet 34 until the numbers 46, 47 and 43 become visible in the guides of Amsterdam, Athens and Atlanta respectively. Thus, the person can read, the 14:00 hours in Amsterdam, the 15:00 hours in Athens and the 8:00 hours in Atlanta, meaning that each city now has one-hour in advance in relation to its previous time.

FIG. 4 is a view of the world timepiece of FIG. 2 when a conveyor 36 is used. In this conveyor 36 the Pointer Guides appear drawn. Conveyor 36 is a transport mean of the Pointer Guides, which are visible through transparent windows 37a, 37b in the forepart 33 of the world timepiece. The Pointer Guides are displaced from a time number to the following ascending time on the time display, fact that occurs due to the displacement of conveyor 36. These world timepieces are elaborated with predetermined materials and their dimensions depend on their purpose and use.

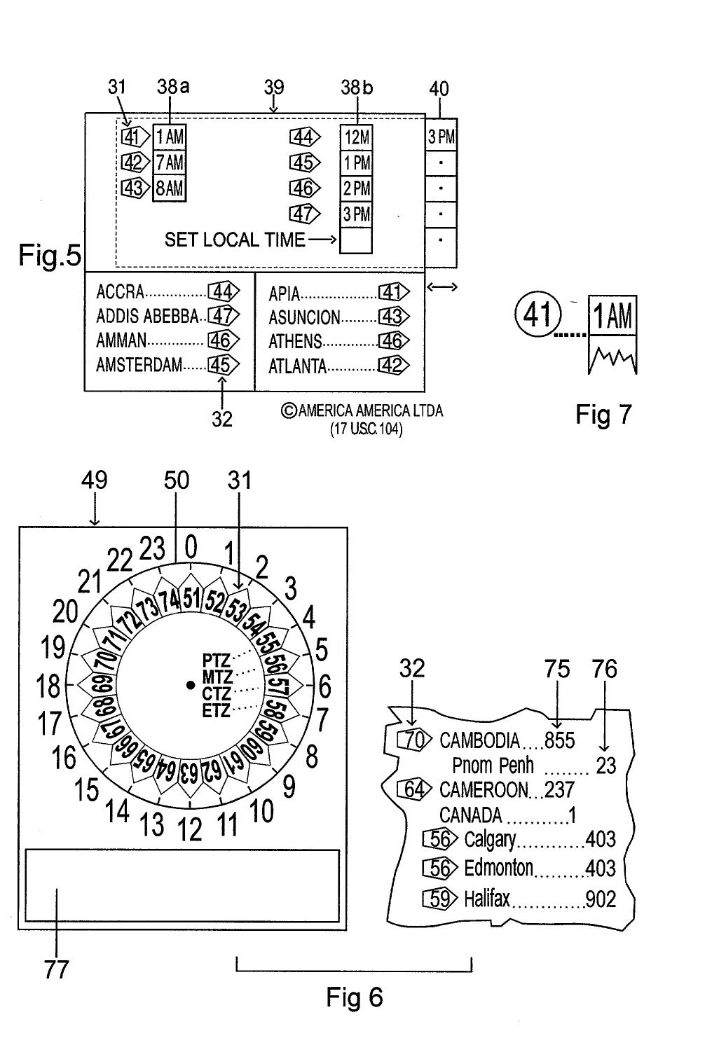

FIG. 5 is a frontal view of a world timepiece made with appropriate materials to be printed. This world timepiece also uses a plural number of Accompany Guides 32 and Pointer Guides 31. The Pointer Guides 31 are fixed on forepart 39. A transport Sheet 40 is located behind forepart 39. This transport sheet 40 transports a time display. In forepart 39 two cut windows 38a, 38b were made and their materials were withdrawn and then, the time numbers became visible. Transport Sheet 40 is manually displaced. The dimensions of these world timepieces are the adequate ones according to their purpose and use.

FIG. 6 is an explode view of a telephone directory world timepiece. The left drawing shows a time disc, which is made with appropriate materials to be printed. The time display is printed on forepart 49. The disc 50 has 24 Pointer Guides 31 and is manually turned. The right drawing presents a cut printed sheet of the said telephone directory, which shows some country and city names. it also appears some area codes 76, 77 and other numbers that any person has to dial in order to make an international phone call.

In the same piece of sheet of the directory can be observed that an Accompany Guide 32 accompanies Cambodia and Cameroon names. Each Canada city name appears accompanied by an Accompany Guide 31, due to Canada's time zones. Some telephone directories do not have geographical names: country and city names.

In the forepart 49, there is an available space 77 for the instructions.

The telephone directories are made to facilitate phone calls. This is not true for international phone calls because they do not inform the time in the call receptor country, city or island. Due to the absence of this information:

People loose time and money when the called persons are outside homes, due to the labor time.

People also loose time and money when the called persons are not working, due to the time for lunch or when the labor has ended.

Imprudent phone calls make people furious, fact that is very common and occurs when they are sleeping.

When people need to speak to a specific person the answer machines also make people loose calls, this mean time and money.

The time disc, the Pointer and Accompanies Guides Induce will improve telephone directories.

FIG. 7 shows a non-pointed symbol which induces to read time; it is an inducer mean.

The guides are differentiated by the number, but can also be differentiated by color, form, or a combination of any of these characteristics. Color Pointer Guides and color Accompany-Guides give the world timepieces a colorful and beautiful appearance. 4

To a color Modifiable-Accompany Guide, as a yellow one, it is possible to change its color for another one, such as red. It could be achieved in the same way as I explained it on FIG. 3. It can also be achieved with self-adhesives, with any two-face element etc.

In the world timepieces of FIGS. 2 and 3, according to the position of disc 30, which rotates, the numbers of the Pointer Guides can be observed right-side up, inclined or upside down. These world timepieces function better by replacing the numbers for colors.

The world timepieces of FIGS. 2 and 3 can also be made with appropriate materials to be printed. In these world timepieces the transport mean, the disc 30, is manually turned.

To make an easy description of my world timepieces I used the elements Pointer Guide and Accompany Guide but in the Claims my world timepieces only have Inducer Means. The Inducer Means make the same work of the Pointer Guides and of the Accompany Guides. Now, anyone who reads my Claims will not have difficulty to understand my world timepieces. The person will know how to associate a specific Claim with one or more drawings.

### SUMMARY, RAMIFICATIONS AND SCOPES

Accordingly, the reader will see that the world timepieces resulting from this invention can be elaborated in large dimensions to be placed in airports, subways and other places with many pedestrian, thus inform world time in a massive way. They also serve to be inserted in telephone books, where each person can likewise be informed of the world time. Furthermore, the world timepieces have additional advantages:

They allow the different time to be informed simultaneously.

They allow beautiful appearance with different colors.

They allow the dial not to be congested with information.

They allow any person to understand world time easily.

They allow the presentation of the geographical names in alphabetical order.

They allow the world timepieces to be adjusted to Standard Time and Daylight Saving Time.

There are many advantages provided by the world timepieces of this invention. It will allow its use to replace the sets of 5, 6, or more conventional clocks of 12 hours dial and hands, which are currently placed in airports, hotels, television news, etc.

Although the description above contains many specifications, these should not be constructed as limiting the scope of the invention, but as merely providing illustrations of some of the presently preferred embodiments of the invention. For example, my world timepieces can have other shapes, such as circular, oval, trapezoidal, etc.

Thus the scope of the invention should be determinate by the appended claims and their legal equivalents, rather than the examples given.

I claim:

I. A world timepiece comprising,
A) a plural number of different inducer means; each said inducer mean induces to read a different zone time; some of said inducer means are found in a transport mean, which is next to a time display, so that each said inducer mean appears next to a specific time; the rest of said inducer means appear in a geographical name list, where each said inducer mean accompanies a geographical name in any way; in the geographical name list said inducer means are:
when each geographical name belongs to a different time zone said inducer means are different among each other;
when the geographical names belongs to the same time zone said inducer means are identical;
said inducer mean, which accompanies a geographical name, is identical to one of said inducer mean that appear next to the time display; it is the identical; both identical inducer means induce to read the chosen geographical place time;
B) a transport mean to transport said inducer means; said transport mean is displace with the accuracy of a clock system;
any person will be attracted to observe that there is said inducer mean accompanying the chosen geographical name; it is logical that the person thinks about its meaning; the answer will be found upon observing that said inducer mean is identical to said inducer mean that appears next to a specific time, so that person will deduce that the time read is the chosen geographical place time;
my world timepiece is made with predetermined materials and its dimensions are the adequate ones according to its purpose and use;
said inducer means present the following advantages;
first: they allow the elaboration of this world timepiece, whereby a person can satisfy the need to know the world time;
second: it is possible to adequately organize this world timepiece, whereby a person will not be confused upon reading the different indicated time;
third: it is possible to present the geographical names in alphabetical order, whereby a person can easily find the desired name;
fourth: it is possible to simultaneously inform the different world time, whereby many people can read at the different geographical places at the same time, and,
fifth: it is possible to adjust the world timepiece to the changes of time, whereby a person can correctly be informed of the world time in daylight saving time and in standard time.

2. The world timepiece of claim 1 further including,
A) a plural number of modifiable inducer means; each said modifiable inducer mean accompanies a geographical name in any way; modifiable signifies that they are equipped in other to modify their appearance; said modifiable inducer mean is any device equipped to change its appearance;
in theory, in standard time, said modifiable inducer mean, which accompanies a chosen geographical name, must be identical to one of said inducer mean which appears next to a specific time; in daylight saving time said modifiable inducer mean must change in order to be identical to said inducer mean which appears next the following ascending hour of the time display; this signifies that the person can read the time of the chosen geographical name in daylight saving time.

3. The world timepiece of claim 1 wherein said transport mean transports the time display and each said inducer mean that appears next to a specific time, are fixed.

4. A world timepiece made with appropriate materials to be printed, comprising,
A) a plural number of different inducer means; each said inducer mean induces to read a different zone time; some of said inducer means are found in a transport mean, which is next to a time display, so that each said inducer mean appears next to a specific time; the rest of said inducer means appear in a geographical name list, where each said inducer mean accompanies a geographical name in any way; in the geographical name list said inducer means are:
when each geographical name belongs to a different time zone said inducer means are different among each other;
when the geographical names belong to the same time zone said inducer means are identical;
said inducer means which accompanies a geographical name, is identical to one of said inducer mean that appear next to the time display, it is the identical; both identical inducer means induce to read the chosen geographical place time;
B) a transport mean to transport said inducer means; said transport mean is manually activated;
any person will be attracted to observe that there is said inducer mean accompanying the chosen geographical name; it is logical that the person thinks about its meaning; the answer will be found upon observing that said inducer mean is identical to said inducer mean that appears next to a specific time; so that the person will deduce that the time read is the chosen geographical place time; my world timepiece has the appropriate dimensions according to its purpose and use;
said inducer means present the following advantages:
first: they allow the elaboration of this world timepiece, whereby many people can satisfy the need to know world time;
second: it is possible to adequately organize this world timepiece, whereby a person will not be confused upon reading the different indicated time;
third: it is possible to present the geographical names in alphabetical order;
fourth: it is possible to simultaneously inform the different time around the world, whereby many people can read the time of the different geographical places at the same time.

5. The world timepiece of claim 4 wherein said transport mean transports the time display and each said inducer mean that appears next to a specific time, are fixed.

6. A telephone directory comprising,
A) a time display;
B) a plural number of different inducer means; each said inducer mean induces to read a different time of said time display, some of said inducer means are found in a transport mean, which is next to said time display, so that each said inducer mean appears next to a specific time; each one of the rest of said inducer means accompanies a geographical name in any way;
C) a plural number of geographical names that appear in the directory; some of said geographical names are accompanied by the area codes and other said geographical names are accompanied by other numbers that any person has to dial in other make an international phone call;
said inducer means, which accompany said geographical names, are:
when each said geographical name belongs to a different time zone said inducer means are different among each other;
when said geographical names belong to the same time zone said inducer means are identical;
said inducer mean that accompanies to said geographical name, is identical to one of said inducer means that appear next to said time display, it is the identical; both identical inducer means induce to read the geographical place time;
D) a transport mean, to transport said inducer means; said transport mean is manually activated;
E) a plural number of instructions that explain how to find the chosen geographical place time;
with my telephone directory people can to know the call receptor place time, whereby the can make efficient communications, saving time and money

7. The directory of claim 6 wherein said transport mean transports said time display and said inducer means, which appear next to said time display, are fixed.
